(19) United States
(12) Patent Application Publication
(10) Pub. No.: US 2009/0136693 A1
(43) Pub. Date: May 28, 2009

(54) Container Produced Using an Injection Molding Method, and Plastics Film Label Provided for Over-Molding With Plastics

(76) Inventor: Alfons Schmunkamp, Lohne (DE)

Correspondence Address: COLLARD & ROE, P.C., 1077 NORTHERN BOULEVARD, ROSLYN, NY, 11576, US

(21) Appl. No.: 11/922,640

(22) PCT Filed: Jun. 22, 2006
(86) PCT No.: PCT/EP2006/063436

§ 371 Date: Dec. 20, 2007

(30) Foreign Application Priority Data
Jun. 23, 2005 (DE) 10 2005029610.6

(51) Int. Cl. G09F 3/04; B65D 25/20; G09F 3/02

(52) U.S. Cl. 428/34.1; 428/192

(57) ABSTRACT

The invention relates to a container (1) which is produced using an injection molding method and comprises an over-molded label (2) applied to the outer side thereof, said label (2) comprising an overlapping section (5) located between a front edge (4) and a rear edge (3). The invention also relates to a plastic film label (2) which is to be over-molded with a plastic material and comprises two edges suitable for the overlapping during the production. The aim of the invention is to improve one such container or label, especially in terms of the container, in such a way that a notch effect in the region of the label overlapping is counteracted. To this end, one of the edges (3, 4) comprises a plurality of recesses (7) in the extension direction of the overlapping (5), such that the edge (3, 4) alternates about a straight line (a-a) corresponding to the course of the overlapping (5).

The invention relates in first instance to a container produced using an injection molding method and having an externally applied, over-molded label, the label having an overlap between a front and a rear edge.

Containers of the kind under discussion are known. These have a circumferential label on the outside in the form of a band which is over-molded by the plastics material of the container in the course of manufacture of the container. An In-Mould-Label is thus created. The label is accordingly non-releasably connected to the container. In the case of thin-walled containers, there exists however the problem that a reduction in wall thickness occurs on account of the label overlap, as a result of which a notch effect can come about along the edge of the overlap. In the case of high lateral loading, rupture can result and this can also lead to leakage.

In regard to the state of the art described above, a technical problem for the invention is seen in configuring a container of the kind under discussion in an improved manner such that a notch effect in the region of the overlap is countered.

This problem is solved first and foremost by the subject matter of Claim 1, it being provided that at least one of the edges has a plurality of formations in the direction of extent of the overlap, so that the edge alternates about a straight line which corresponds to the extent of the overlap. As a result of this configuration, the reduction in wall thickness which runs in a straight line in the known state of the art is interrupted in its extent. Accordingly, there exists no defined line of failure and as a result, a notch effect with the consequent danger of the occurrence of a rupture in the case of external loading is countered. The proposed formations are provided at least on one of the overlapping edges of the label. The extent of the edge is thereby lengthened compared with a direct, straight-line edge, extending at an angle of 90° with respect to the circumferential edge of the label. The formations are in the form of protruding portions and set-back portions—as seen in the direction of extent of the original label prior to over-molding—which are respectively forward of and to the rear of a notional edge which runs originally in a straight line, so that, as seen in the direction of extent of the edge, a material cut-out is in each case positioned between two material portions defining the edge. In this region, the material cut-out is, in the course of the over-molding, pressed into the overlapping region of the other edge of the label, as a result of which no doubling of the thickness of the label exists in the this region. Thickness doubling is only established in the region neighbouring the material cut-out. Accordingly, there alternate along a notional straight line, which runs parallel to a linear edge of the label, which may be present at the other end, portions having doubled label thickness and portions having one a single label thickness. The container produced does not therefore have, along this line, any continuous reduction in wall thickness. The container wall is stabilized and is able, in particular, to withstand lateral loads.

The subjects of the other claims are explained below with reference to the subject matter of Claim 1, but may also be important in their independent formulation.

Thus in a development of the subject of the invention, it is provided both edges have formations. In this regard, one edge may be wavy. Further, a jagged edge is also possible, as are still further formations, thus for example in the form of a saw-tooth or a right angle profile. In one configuration, in which both edges of the label have formations of this kind, they may be formed to be the same. Alternatively, the formation of one of the edges may be shaped differently from the formations of the other edge. Also differently shaped formations may be provided over the length of the edge. The formations may be selected in their extent—both in the direction of extent of a straight line running parallel to a straight edge which may be present as well as at right angles to this with respect to the extent—so that a formation has a width at its base which equates to one-hundredth to one-half of the width of the label in the region of the overlap, thus further for example one eightieth, one fiftieth, one twenty-fifth, one fifth or one third. The base of the formation thus corresponds approximately to a wavelength, for example for a uniformly wavy edge, the base width equating to a hundredth with respect to the width of the label in the region of the overlap or with reference to the length of the notional line for an arrangement with for example one hundred waves, and equating to half the width in the case of an arrangement of only two waves. The dimension of the extent transverse to the notional line (in the figurative sense, the phase height for a wavy edge) equates approximately to one tenth to one hundredth, preferably to one fortieth, of the width of the label in the region of the overlap, thus further also for example one twentieth, one thirtieth, or even also one fiftieth.

The invention also relates to a plastics film label provided for over-molding with plastics and having two edges suitable for overlapping during the processing.

Plastics film labels of the kind under discussion are known. They consist for example of polypropylene and are used for over-molding with a plastics material for the production of an In-Mould-Label for a plastics container. Labels of this kind are selected as to their length so that they surround the container on the outside in the manner of a band, the edges of the label being in addition able to overlap.

In order to further improve a plastics film label of the kind under discussion, it is proposed that at least one one of the edges, which edges are suitable for the overlap, has a plurality of formations in the direction of extent of the overlap, so that the edge alternates about a straight line which corresponds to the extent of the overlap. The extent of the edge is by this lengthened compared with a direct straight-line edge, which runs at an angle of 90° with respect to the edges which run in the elongate extent of the label. The formations are in the form of protruding portions and set-back portions—as seen in the elongate extent of the label—which are forward of and to the rear of a notional edge which runs originally in a straight line, so that, as seen in the direction of extent of the edge, a material cut-out is in each case positioned between two material portions defining the edge.

The subjects of the further Claims 7 to 10 are explained below with reference to the subject matter of Claim 6, but may also be important in their independent formulation.

Thus in a development of the subject of the invention, it is provided both edges have formations. In this regard, one edge may be wavy. Further, a jagged edge is also possible, as are still further formations, thus for example in the form of a saw-tooth or a right angle profile. In one configuration, in which both edges of the label have formations of this kind, they may be formed to be the same. Also differently shaped formations may be provided over the length of the edge.

In addition, the formations are selected so that they have a width at their base which equates to one hundredth to one half of the width of the label in the region of the possible overlap, thus further for example one eightieth, one fiftieth, one twenty-fifth, one fifth, or one third. Thus the base of the formation equates approximately to a wavelength for example in the case of a uniformly wavy edge.

The invention is explained in more detail below with reference to the accompanying drawing, which only illustrates one embodiment. In the drawing:

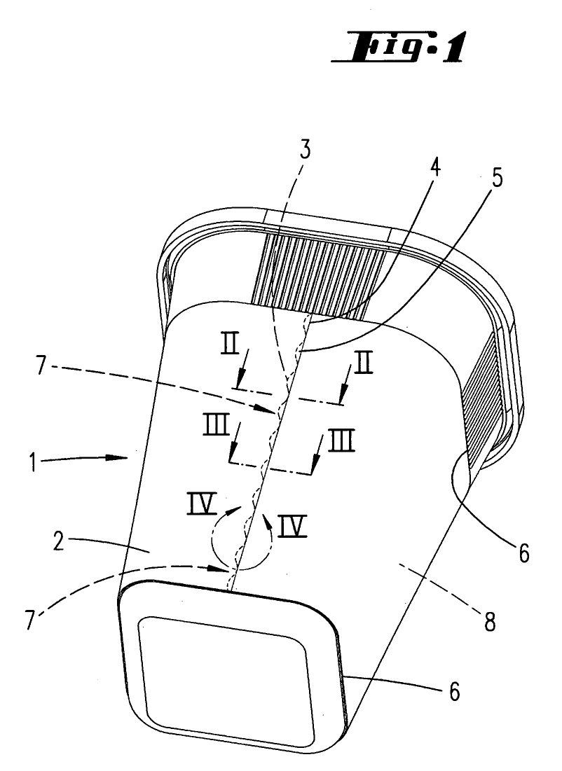

FIG. 1 shows a container produced using an injection molding method and having an externally applied, over-molded label;

FIG. 2 shows the enlarged section on the line II-II in FIG. 1;

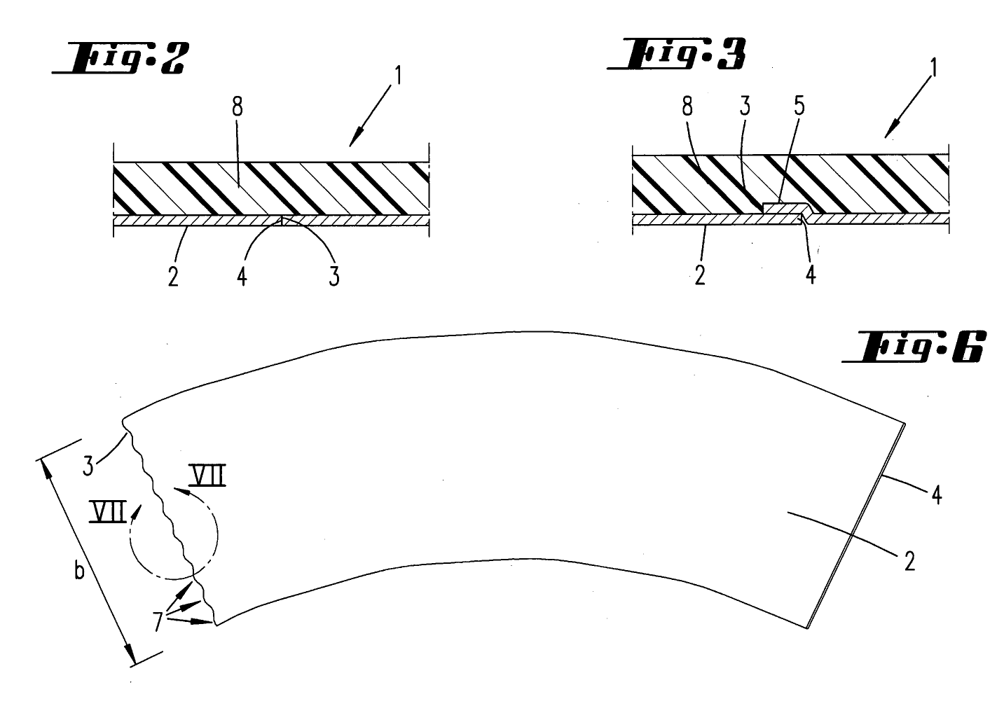

FIG. 3 shows the section on the line III-III in FIG. 1, illustrated in enlarged form;

FIG. 4 shows the enlargement of the region IV in FIG. 1;

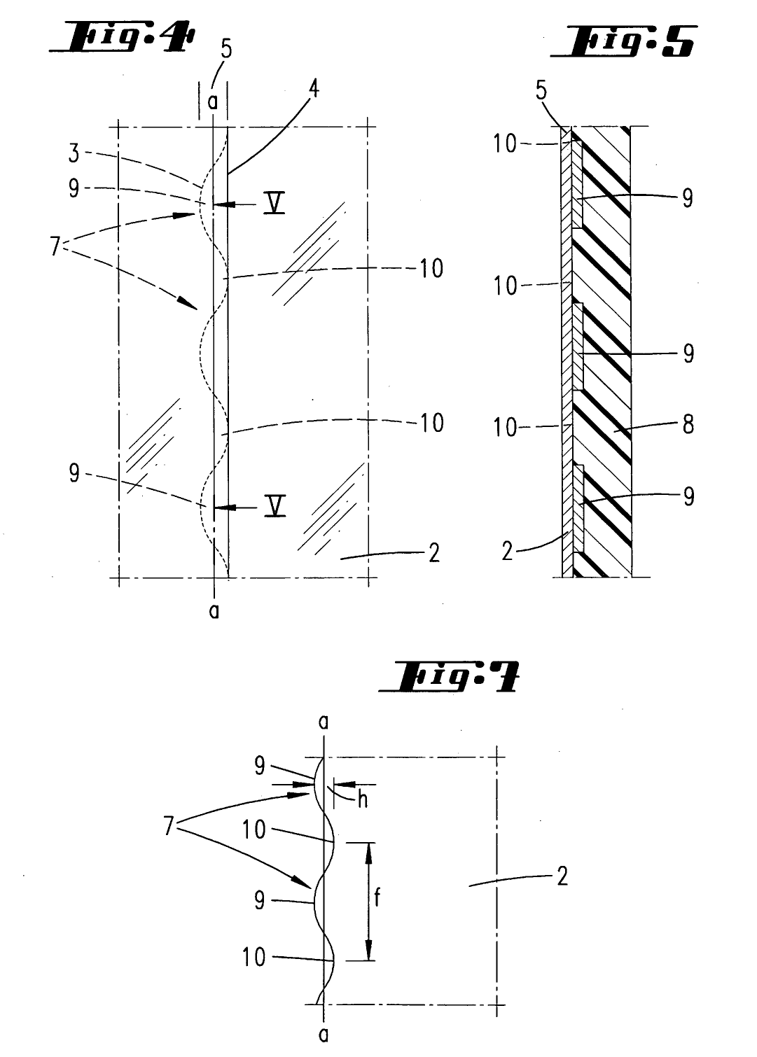

FIG. 5 shows the section on the line V-V in FIG. 4;

FIG. 6 shows the plastics film label in a detail illustration;

FIG. 7 shows the enlarged illustration of the region VII-VII in FIG. 6.

The container 1 illustrated in FIG. 1 is produced using the plastics injection molding method and has a label 2 which is applied externally and is over-molded in the course of the injection-molding manufacture. An In-Mold-Label is accordingly in question.

The label 2 is arranged circumferentially on the outside of the container 1 and is non-releasably connected to the container as a result of the over-molding. The over-molded label 2 has an overlap 5 between a front edge 4 and a rear edge 3.

The two edges 3 and 4 are shaped differently. Thus the front edge 4 has a linear form and encloses a right angle with respect to the edges 6 which are parallel to the container base and container lid respectively.

The rear edge 3 has by contrast shaped formations 7, which are effected by a wave-shaped configuration.

As is to be seen in particular from the detail illustration in FIG. 4, the overlap 5 of the two edges 3 and 4 is selected so that the linearly-extending edge 4 intersects the wave-shaped formations 7 of the other edge 3 in the valley 10 of a wave, so that an overlap, i.e. a doubling of the thickness of the label exists only in the region between two spaced-apart wave valleys. This is achieved by the edge 3 alternating about an imaginary straight line a-a, which corresponds to the extent 10 of the overlap 5 and encloses a 90° angle with respect to the edges 6 which are parallel to the container base and container lid respectively.

In the region of the wave valleys 10 of the edge 3 which are formed by the formations 7, the edge 3 is positioned in planar alignment with the linearly-extending edge 4 (see the sectional illustration in FIG. 2). This is achieved in the course of the over-molding of the label by the plastics material injected into the cavity filling the regions of the wave valleys 10. By contrast, a doubling of the label thickness, as viewed in the thickness direction of the container wall 8, is to be observed in the region of wave peaks 9 (see FIG. 3).

By virtue of the selected edge formation, a uniform tapering of the container wall 8 extending over the width of the label 2 in the overlap region by virtue of a doubling of the label thickness is countered. On the contrary, alternation of the container wall thickness is provided over this elongate portion (see FIG. 5)—and this alternation is uniform is the embodiment illustrated.

As an alternative, the arrangement can be selected so that the linearly-extending edge 4 of the label portion is overlapped by the wavy edge 3, the overlap being also here selected so that the linearly-extending edge 4 intersects the wave-shaped formations 7 of the edge in the wave valleys 10.

In the course of the over-molding of the label thus inserted into the cavity, the injected plastics material effects a pressing-in of the label portions associated with the edge 4 and located in overlap with the wave valleys 10 into the region of the wave valleys 10 and thus into the plane of the label portion having the formations 7. As a result, a single-layered arrangement of the over-molded label 2 is also achieved in this way in the region of the wave valleys 10.

The plastics film label 2 is shown in a detail illustration in FIG. 6. This has, according to the use in question, a linearly-extending edge 4 and a wavy edge 3 which has formations 7.

Uniformly distributed formations 7 are provided across the width b of the label 2 or its edge 3, each formation 7 having a wave peak 9 and wave valley 10. In its base, measured from the point of reversal in one wave valley 10 to the point of reversal of the neighbouring wave valley 10, each formation 10 has a width f, which in the embodiment illustrated equates to one tenth of the width b of the label 2. The height h of each formation 7 measured at right angles to this—measured between the point of reversal of a wave valley 10 and the point of reversal of a wave peak 9—is about one fortieth of the label width b.

All disclosed features are (in themselves) pertinent to the invention. The disclosure content of the associated/accompanying priority documents (copy of the prior application) is also hereby included in full in the disclosure of the application, including for the purpose of incorporating features of these documents in claims of the present application.

1. Container (1) produced using an injection molding method and having an externally applied, over-molded label (2), the label (2) having an overlap (5) between a front (4) and a rear (3) edge, wherein at least one of the edges (3, 4) has a plurality of formations (7) in the direction of extent of the overlap (5), so that the edge (3, 4) alternates about a straight line (a-a) which corresponds to the extent of the overlap (5).

2. Container according to claim 1, wherein both edges (3, 4) have formations (7).

3. Container according to claim 1, wherein the edge (3, 4) is wavy.

4. Container according to claim 1, wherein the edge (3, 4) is jagged.

5. Container according to claim 1, wherein a formation (7) has a width (f) at its base which equates to one-hundredth to one-half of the width (b) of the label (2) in the region of the overlap (5).

6. Plastics film label (2) provided for over-molding with plastics and having two edges (3, 4) suitable for overlapping during the processing, wherein at least one of the edges (3, 4), which edges are suitable for the overlap (5), has a plurality of formations (7) in the direction of extent of the overlap, so that the edge (3, 4) alternates about a straight line (a-a) which corresponds to the extent of a possible overlap (5).

7. Label according to claim 6, wherein both edges (3, 4) have formations (7).

8. Label according to claim 6, wherein the edge (3, 4) is wavy.

9. Label according to claim 6, wherein the edge (3, 4) is jagged.

10. Label according to claim 6, wherein a formation (7) has a width (f) at its base which equates to one-hundredth to one-half of the width (b) of the label (2) in the region of the possible overlap (5).
